(19) United States
(12) Patent Application Publication
(10) Pub. No.: US 2020/0375385 A1
(43) Pub. Date: Dec. 3, 2020

(54) CURTAIN BRACKET MOUNTING DEVICE

(71) Applicant: Uche Onyegasi, Fresno, CA (US)

(72) Inventor: Uche Onyegasi, Fresno, CA (US)

(21) Appl. No.: 16/425,351

(22) Filed: May 29, 2019

(51) Int. Cl. A47H 1/122; F16B 1/00

(52) U.S. Cl. CPC A47H 1/122; F16B 2001/0028; F16B 1/00

(57) ABSTRACT

The present invention provides a temporary curtain rod bracket support. The apparatus of the present invention is operable to provide an even distribution of weight amongst the mounting member. Curtain rod brackets are often fastened to a surface with screws and/or nails; this method attaches a curtain rod bracket without damaging the mounting surface. The rod bracket takes use of joining materials which do not penetrate the mounting surface but are sufficient in their ability to support the weight of the bracket, rod, and curtains.

### FIELD OF THE INVENTION

The present invention relates to a mechanism for mounting a curtain rod fixture. More particularly, the present invention relates to the use of a temporary curtain fixture.

### DISCUSSION OF THE BACKGROUND

Curtains or drapes are a common item found in homes and workspaces and are placed along a window pane or seal. It is a common item used to enhance the beauty of a home or workspace, and prevent excess light from entering the environment.

Curtains are typically hung with a wooden dowel or rod; curtains are threaded directly through the rod or alternatively may be hung from curtain rings. Curtain rings pierce the curtain material and allow for less resistance along the curtain rod when adjustments of coverage are made. Larger windows require more curtain material to prevent excess light penetration in the space. A curtain rod is supported with a bracket; these brackets often vary in size and material. Brackets are preferred to be seamless and securely mounted to the surface of the wall.

Traditional methods of installing curtains often require the installation of brackets to secure a rod in which the drapery panels are slid on too. The bracket installation often requires drilling into a wall and/or hammering in wall anchors if there is no material to support the bracket. This process often results in damage to the wall surfaces and structural members during the installation of the brackets to the wall; damages include (e.g., paint, wood, etc.). Heavy-duty brackets are often required for curtain rod weights over 20 lbs., which requires drilling bigger holes into the wall. Traditional methods of installing a curtain rod bracket are undesirable for many individuals. As more individuals choose to rent a living space rather than purchase a home, a deposit is often required to obtain this living space, and rod bracket instillation diminishes the return of the deposit. The damage done to the mounting surface is evident when the curtain rod bracket is removed, and this surface must be filled with a drywall compound or a wall repair patch if there is wall shearing due to the removal of the bracket members.

Curtain rods that address some of these issues are on the market and utilize a spring tensioner rod which is adjusted by rotating two portions of a shaft in the opposite direction to the desired length. The limitations of this design require placement of the rod between two parallel planes or walls on either side of the rod. This apparatus often leaves a temporary residue around the contact location of the wall. As curtains also serve as a decorative item in space, this type of curtain rod is often undesirable for interior decoration, due to the window space being reduced and the perspective dimension of the window frame being reduced. Different solutions include hammering a no-drill curtain bracket into the window frame or window molding; this damages the frame and or molding and yields similar issues as the torsional curtain rod.

Improvements for a temporary or semi-permanent curtain bracket are desirable, a temporary curtain bracket which does not damage the structural integrity of a wall and or damage the surface finish.

### SUMMARY OF THE INVENTION

The present invention provides a temporary curtain rod mount which is operable to support a curtain rod with little to no damage to the mounting surface. The device utilizes geometries in which distribute the normal force on the wall evenly.

Accordingly, it is an object of the present invention to provide a temporary wall mount that is capable of attaching to various surfaces and capable of receiving a bracket support plate attachment. The wall mount is operable to attach to various surfaces via, an attachment member in most embodiments, a hook and loop material (Velcro) system is utilized. The wall mount has fastening locations which support latching mechanisms used to mount the bracket support plate.

It is another object of the invention to provide a bracket support plate in which the various fasteners are used to mount to a wall mount; the various fasteners (e.g., clips, magnets, etc.) consist of geometries or locations that are complimentary with that of the wall mount.

In some embodiments, a bumper is added to the lower the portion of the wall mount that absorbs the load acting on the surface of a wall and act as an additional barrier to prevent damage to the mounting surface.

It is another object of the invention to provide a curtain rod bracket capable of holding a curtain rod in place by seating in an angled receiver operable to rotate around a bracket shaft. The weight of the curtain rod applies significant pressure to the bracket which, in turn, is pressed against the support plate. The support plate may include a buffer pad against which the rod bracket rests. The system may also include one or more inserts that may be positioned between the bracket and the support plate to change the angle of the bracket and the angled receiver if desired. For instance, if one desires to hang the bracket on a slightly inclined wall, the inserts may be positioned between the bracket and the support plate to prevent the bracket from hanging unsupported away from the support plate.

In some embodiments, the bracket may include a fastening mechanism that utilizes a spring and pin mechanism and aids in keeping the curtain rod in position. In some embodiments, the spring and pin mechanism is not in contact with the curtain rod. Instead, the mechanism is operable to prevent the post from jerking out of the curtain bracket in the event of a moment force acting on the curtain rod.

It is another object of the invention to provide a curtain rod bracket with a U-shaped geometry; this geometry is naturally incorporated to accommodate the geometries of various curtain rods available to the public. In some embodiments, the U bracket may be modified to accommodate specific geometries (e.g., elliptic, rhombus, etc.).

It is another object of the invention for the rod bracket to be mounted to the bracket support plate; the rod bracket is attached to the bracket support plate via a shaft rigidly attached (e.g., glued, welded, etc.) on the two ends, with space operable to line up the rod bracket accurately between a space within the bracket support plate. The location of the shaft must be operable to allow for the rod bracket to rotate freely about the neutral axis of the shaft without interference from the bracket support plate.

It is further an object of the invention to provide an inexpensive, temporary rod bracket that is easily installed and is sufficient in supporting a curtain rod and curtain, without damaging the mounting surface. These and other objects of the present invention will become apparent upon inspection of the detailed description and drawings.

### BRIEF DESCRIPTION OF THE DRAWINGS

FIG. 1A shows an environmental perspective view of a curtain bracket mounted according to the preferred embodiment of the present invention, device 100.

FIG. 1B shows a close-up view of the device of FIG. 1A.

FIG. 2 shows an exploded trimetric view of the curtain bracket device of FIG. 1A.

FIG. 3A shows an exploded posterior perspective view of the device of FIG. 1A.

FIG. 3B perspective view of the device of FIG. 1A.

FIG. 4A shows a rear view of a bracket support plate of the device of FIG. 1A.

FIG. 4B shows a front view of a wall mount of the device of FIG. 1A.

FIG. 5A shows a semi-exploded view of another embodiment of a curtain bracket mount.

FIG. 5B shows a perspective view of the device of FIG. 5A.

FIG. 6A shows a side view of another embodiment of a curtain bracket mount and a partial kinetic diagram.

FIG. 6B shows a side view of the device of FIG. 6A.

FIG.7A shows a front perspective view of a wall mount of the device of FIG. 6A.

FIG. 7B shows a rear perspective view of a bracket support plate of the device of FIG. 6A.

FIG. 8A shows a side view with a cross-sectional cut of the wall mount of the device of FIG. 6A.

FIG. 8B shows a side view with a cross-sectional cut of the wall mount of the device of FIG. 6A.

### DETAILED DESCRIPTION

References will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

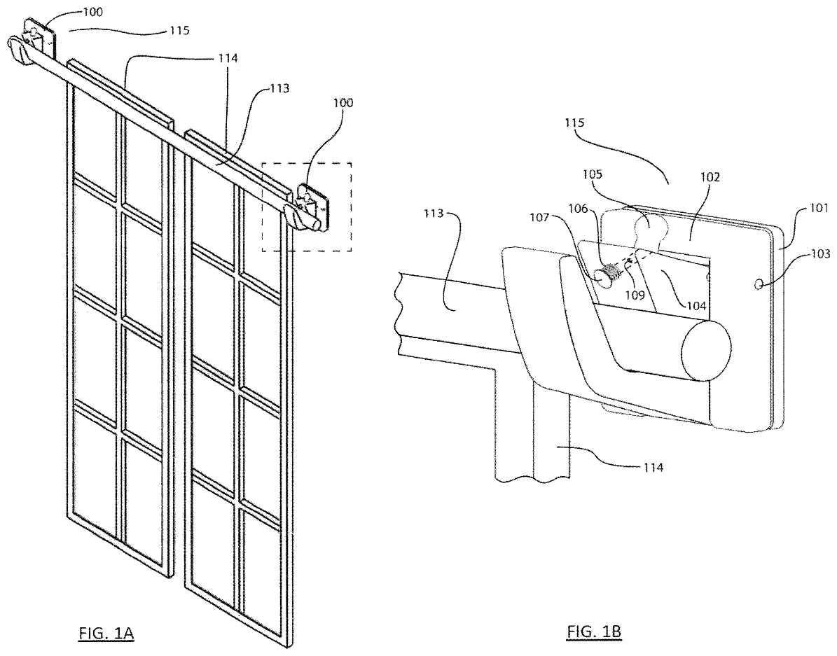

Referring to the drawings wherein like reference characters designate like or corresponding parts throughout the several views, and referring particularly to FIGS. 1A-8B, it is seen that the present invention includes various embodiments of curtain rod mounting device, systems using the same, and methods of using the same.

The curtain rod bracket device of FIG. 1A. shows an environmental perspective of a curtain mounted on a surface, device 100, according to the preferred embodiment of the present invention. Device 100 supports a wooden dowel or curtain rod 113, and is mounted to a surface (e.g., wall) 115; Windows 114 are used to indicate the preferred positioning of the present invention and give a perspective to the scope of the invention.

FIG. 1B shows an expanded trimetric perspective view of the preferred embodiment of the portion indicated in FIG. 1A, device 100. The device includes a wall mount 101, a bracket support plate 102, a bracket shaft 103, and bracket 104; bracket 104 has U-shaped geometry for receiving a curtain rod. The device may optionally include a pull-pin mechanism comprised of a pull-pin 105, spring 106, and pin screw 107. The pull-pin assembly is operable to prevent the curtain rod from unmounting and/or fixing the rod in place.

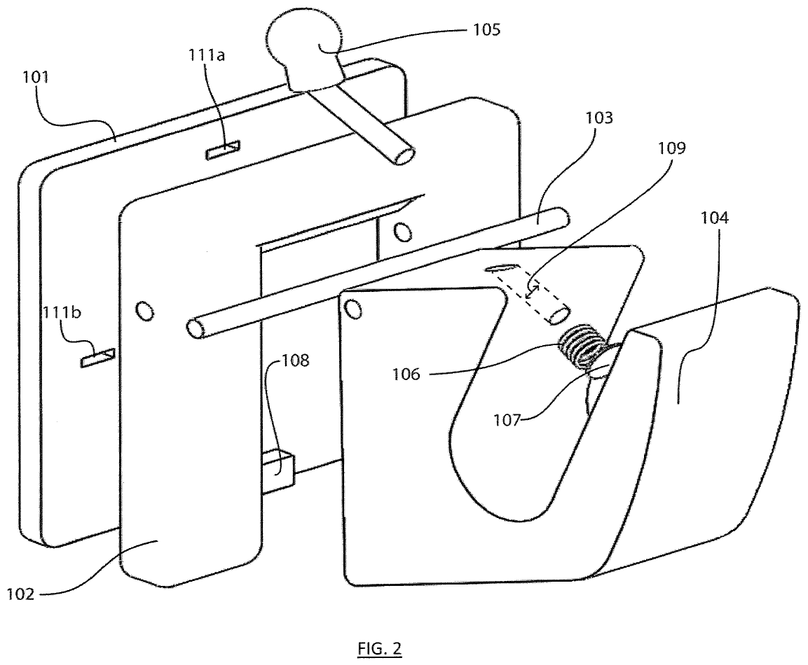

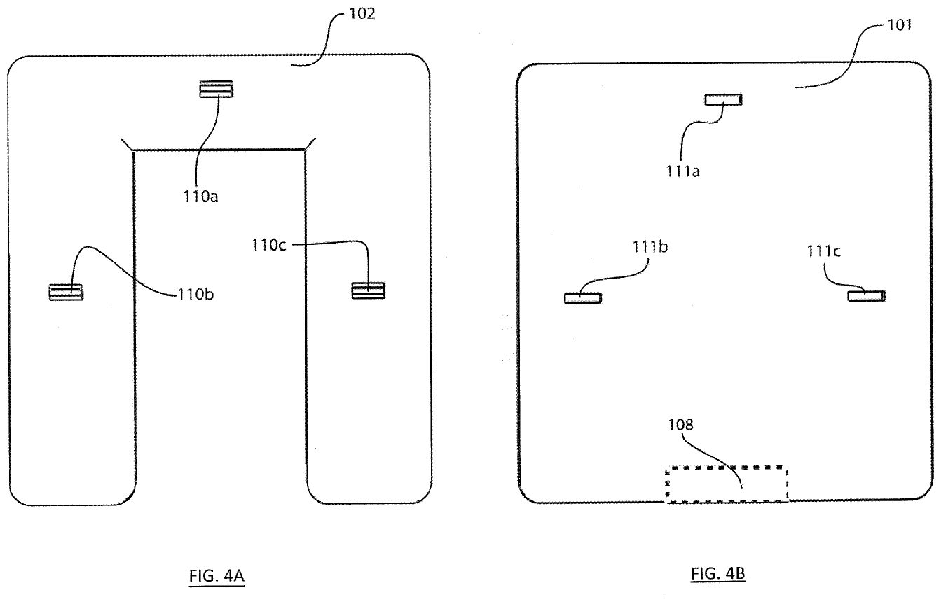

FIG. 2 shows an exploded view of the device of FIG. 1A. The fastener location 111a and 111b are used to attach the bracket support plate 102 to the wall mount 101; the attachment location 111c is not shown due to the perspective of FIG. 2A, the attachments locations, and methods will be further discussed in the description of FIGS. 4A and 4B.

In some embodiments, the device may include a pull-pin mechanism assembled by sliding the pull-pin 105 through the shaft insert 109 on the top surface of bracket 104; the spring 106 is placed around the portion of the pull-pin 105 exposed within the U-shaped cavity of the bracket 104, and the pin screw 107 is tightened fixing the spring 106 in place. The pull-pin assembly must be retracted to insert the curtain rod 113; this is accomplished by pulling the pull-pin laterally. The wall mount may have a bumper 108 to support the bracket and prevent damage to the mounting surface and further absorbs pressure from the rotational moment of curtain rod bracket 104.

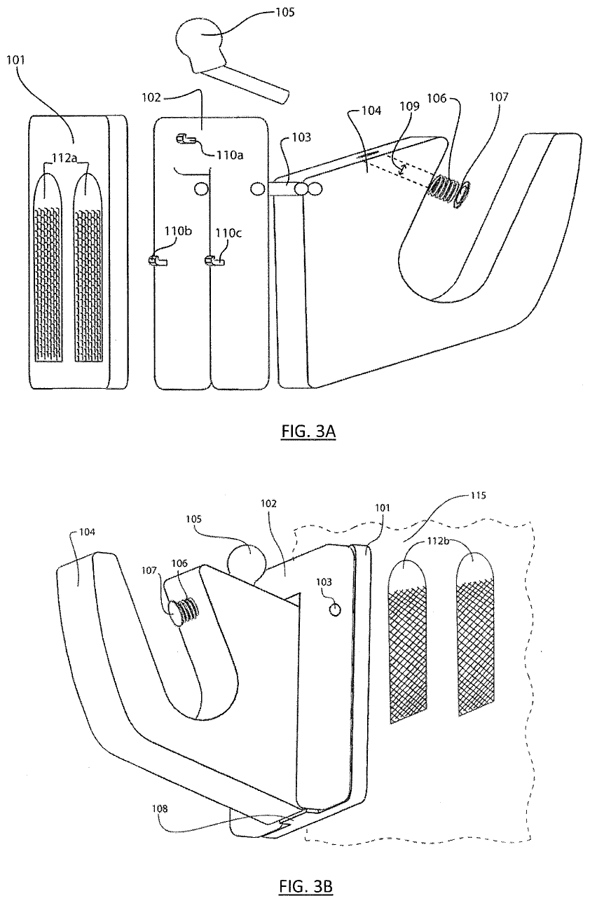

FIG. 3A shows an exploded posterior view of the device of FIG. 1A, according to the preferred embodiment of the present invention, a pair of retractable hook and loop material (e.g., Velcro) members 112a are examples of an attachment member utilized to the attach wall mount 101 and to the surface 115. The bracket support plate 102 utilizes fasteners 110a, 110b, and 110c as a method of fixing the bracket support plate 102 to wall mount 101. In some embodiments, it may be advantages to replace the hook and loop material 112a with a more permanent material (e.g., liquid nail, mounting tape, etc.) that will reduce the potential for damage to the surface. FIG. 3B shows a wall cutout, and the device of FIG. 1, the placement of the wall attachment member 112b is complementary to that of 112a on wall mount 101 shown in FIG. 2B. The attachment member 112b is pressed on to the surface 115 and is given time to sufficiently cure to surface 115. The attachment members 112a and 112b are bonded, and device 100 is equipped to receive curtain rod 113. In some embodiments, a plurality of attachment members 112a and 112b may be utilized to attach wall mount 101 to the surface 115.

The wall mount 101 may be constructed of various materials (e.g., a rigid rubber material, lightweight metallic material, wood, etc.). The bracket support plate 102 may be constructed of wood, plastic or materials to that of wall mount 101. The bracket 104 constructed of a similar material to that of the bracket support plate 102. The bracket shaft 103 may be constructed of aluminum material and fixed in place with an adhesive (e.g., glue, solder, etc.) on either end of the bracket shaft 103 and bracket support 102. The pull-pin 105 and pin screw 107 are constructed of similar materials of the bracket support 102, and the compression spring 106 is constructed of non-ferrous metals such as spring steel. In some embodiments, it would be advantages to use magnets in place of a spring. Bumper 108 is extruded off the wall mount with the intent of absorbing loads and impacts from the curtain rod bracket 104 and would be constructed of a similar material respectively. In some embodiments, bumper 108 may be omitted from the device.

FIG. 4A shows a posterior view of the bracket support plate 102 and shows the location of fasteners 110a, 110b, and 110c; the locations strategically selected to distribute the weight and stress from the bracket 104 evenly amongst the fasteners 110a, 110b, and 110c. These locations are not stringent to the function of the present invention. Instead, it demonstrates the symmetry need to provide an even distribution of weight on fastening members; this is preferable and prevents unnecessary stress concentrations amongst the fastening members. The size of the fastening members may vary dependent on the weight required to support the curtain rod.

FIG. 4B shows a front view of the wall mount 101 and the fastener locations 111a, 111b, and 111c. The locations are used to secure bracket support plate 102 and are operable for receiving the fasteners 110a, 110b, and 110c, the attachment members and fastening location have a geometry that is complementary to one another.

Installation of the device is done by measuring the desired mounting locations for the wall mounts 101 and attaching the attachment members 112b to the desired mounting surface 115. Once the attachment members 112b have cured sufficiently to the mounting surface, the wall mount 101 may be attached to the surface with attachment members 112a. The bracket support plate 102 is then attached to the wall mount 101 by engaging the fasteners 110a, 110b, and 110c with fastener locations 111a, 111b, and 111c.

Insertion of the curtain rod 113 to the rod bracket 104 may be accomplished by pulling the pull-pin 105 in the retracted position, and the wooden dowel/curtain rod 113 may be slid into the bracket 104, the pull-pin 105 is then released locking the rod into the desired configuration.

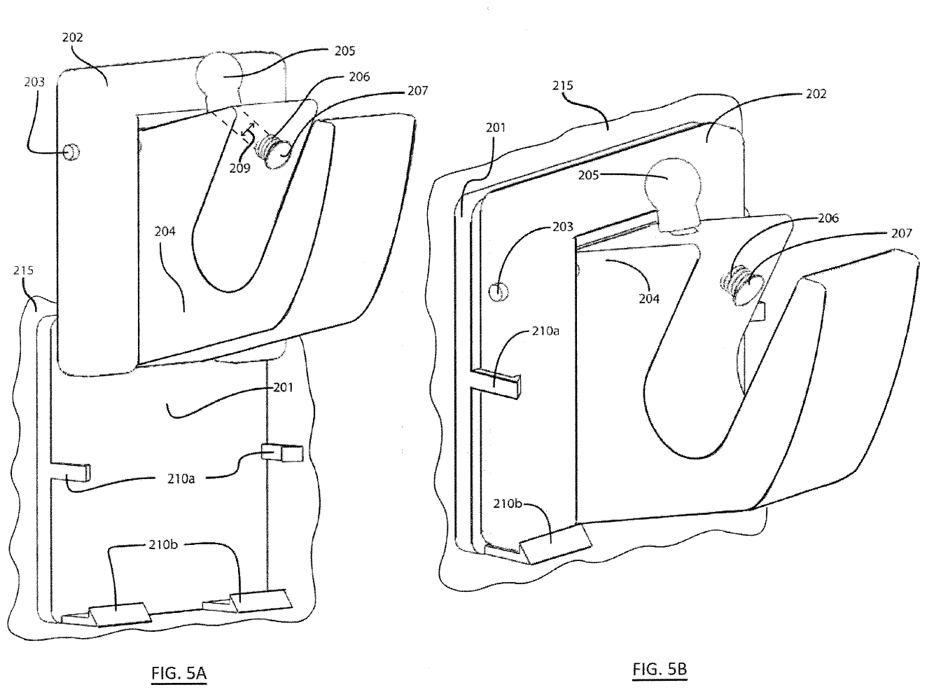

The curtain rod mount device of FIG. 5A. shows another embodiment of the present invention, specifically another example of attaching the bracket support plate to the wall mount, device 200. The device includes a wall mount 201, a bracket support plate 202, a bracket support shaft 203, and a rod bracket 204. The device also includes a pull-pin assembly comprised of a pull-pin 205, spring 206, and pin screw 207. The pull-pin assembly is assembled at the shaft insert 209 on bracket 204; pull-pin 205 is slid through the shaft insert 209 on the top portion of the bracket 203, the spring 206 is placed, and the pin screw 207 is tightened fixing the rod lock. The bracket support plate 202 is snapped or slid into place on the wall mount and engaged and held in position with the snap fasteners 210a and 210b. Device 200, may be constructed of materials in the same of the preferred embodiment.

The wall mount 201 is attached to the wall using methods of the same from the preferred embodiment. The bracket support plate may then be slid or snapped into the fixed position. The advantages of this configuration allow for an even distribution of weight amongst the base fasteners 210b; this configuration is capable of supporting more weight.

FIG. 5B shows a perspective view of the device of FIG. 5A, the device is in its mounted position and is operable to receive the curtain rod using methods of the same from the preferred embodiment.

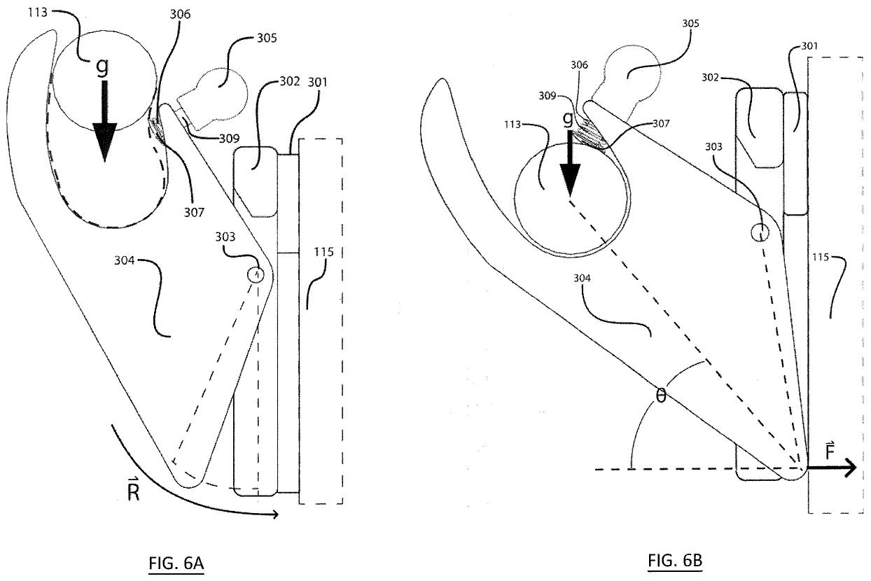

FIG. 6A shows a lateral view of another embodiment of a curtain bracket mount, with a cross-sectional cut of the bracket support plate 304 and the wall mount 301, device 300. The wall mount 301 is parallel to a surface 115 and temporarily fixed, using methods of the same described in FIG. 4A and FIG. 4B. The base surface of the mount is parallel to the ground and the perpendicular to the mounting surface 115. The device comprises a wall mount 301, bracket support plate 302, a bracket shaft 303, and a curtain rod bracket 304. The curtain rod bracket 304 is operable to receive a curtain rod 113; a pull-pin mechanism is utilized to secure the curtain rod; a pull-pin 305, a spring 306, a pull-pin shaft 309, and a pin cap 307 comprise the pull-pin mechanism. The pull-pin shaft 309 is inserted through a bored cylinder on the top face of curtain rod bracket 304, the spring 306 is slid over the pull-pin shaft 309, and the pin-cap 307 secures the spring 306 to the inner face of the curtain rod bracket 304. The pull-pin mechanism is retracted by pulling the pull-pin 305 upwards, which compresses the spring 306. As the pull-pin is retracted the curtain rod bracket 304 rotates clockwise about the bracket shaft 303, and the pull-pin opens a passage allowing the curtain rod 113 to nest into the curtain rod bracket 304. Once the curtain rod 113 is nested into the curtain rod bracket 304 the bracket rotates counterclockwise shown with the rotational vector \vec{R}. The rotation of the curtain rod bracket 304 about the curtain bracket shaft 303 is caused by the weight of curtain rod 113 is indicated by the letter g.

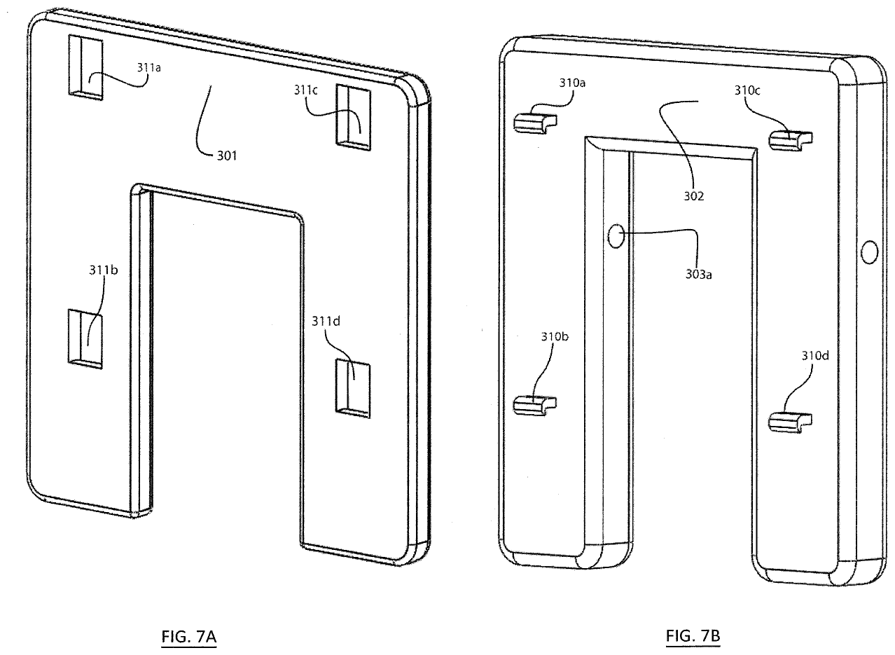

FIG. 6B shows the same lateral view of the device of FIG. 6A, in a settled position after the rod bracket 304 has rotated into the fixed position. The curtain rod 113 is fixed in place as a result of the contact from pin-cap 307. The rod bracket 304 has rotated through a space of the supporting members making contact with the surface 115.The weight of the curtain rod 113, represented with the letter g, is distributed amongst the bracket shaft 303 and the contact location of the curtain rod bracket 304 and the mounting surface 115. The force \vec{F} is normal to the mounting surface. The angle of incidences from the deep loop and rod weight are represented with the symbol θ, which may be an acute angle relative to the ground plane. As the bracket shaft 303, experiences a bending moment the fixed locations of the bracket support plate 302 absorb the majority of mechanical stress. Accordingly, the stress from this configuration is distributed amongst the attachment members FIGS. 3A and 3B, and fastening members, 310a, 310b, 310c, and 310d; references to fastening members will be made in FIG. 7B.

In some embodiments the posterior portion of bracket 304 in contact with wall mount 301 is parallel; this configuration would distribute the weight evenly along the wall mount 301, and relieve the stress of the bending moment acting on the bracket shaft 303 and further prevent damage to the mounting surface 115. Device 300 may be constructed of materials in the same of the preferred embodiment.

In other embodiments, the wall mount 303 may have an absorbent layer of material on the inner face of the wall mount 303.

FIG. 7A shows a front perspective view of the wall mount 301 and the fastening slots 311a, 311b, 311c, and 311d of the device of FIG. 6A. These locations are operable to receive fastening clips 310a, 310b, 310c, and 310d on the bracket support plate 302 shown in FIG. 7B. The fastening slots 311 have geometry complementary to that of the fastening clips 310. The void of material on wall mount 301 has a width synonymous with the bracket support plate 302; the height of the void is a distance above the curtain bracket shaft slot 303a of the bracket support plate 302 this void prevents interference from curtain rod bracket 304 and wall mount 301.

FIG. 7B shows a posterior perspective view of the bracket support plate 302 and exposes the fastening clips 310a, 310b, 310c, and 310d of the device of FIG. 6A. Fastening clips 310 are symmetrical with respect to the vertical central axis of the bracket support plate 302. The bracket shaft slot 303a is designed to have a diameter nest the bracket shaft.

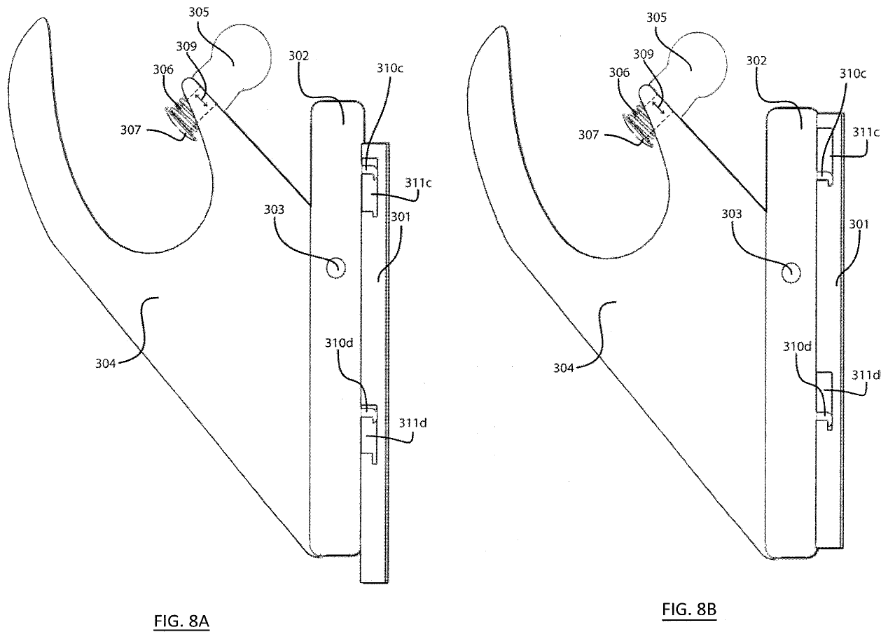

FIG. 8A and FIG. 8B shows a right view of the device of FIG. 6A with a cross-sectional cut of the wall mount 301 exposing the geometry of the fastening slots 311c and 311d. The two figures demonstrate a method of installing the bracket support plate 302 to the wall mount 301. Wall mount 301 is fixed to the surface 115 using methods of the preferred embodiment. Fastening clips 310 are lined up with the fastening slot 311, the support plate 302 is pressed into the wall mount and slid down into the final position shown in FIG. 8B.

The installations of the curtain bracket mount of the device of FIG. 6A use methods of the same of the preferred embodiment.

What is claimed:

1. A device for supporting a curtain rod, which comprises:
a. a curtain rod bracket operable to receive a curtain rod;
b. a bracket shaft about which said rod bracket may rotate;
c. a bracket support plate, comprising at least one fastener with a pre-determined geometry;
d. a wall mount, comprising at least one joining location for receiving said fastener, wherein said joining location is complementary to the geometry of said fastener; and
e. an attachment member operable to attach said wall mount to a mounting surface.

2. The device of claim 1, wherein said curtain rod bracket has a U-shaped geometry operable for nesting a curtain rod and prevent slip via a locking mechanism.

3. The device of claim 2, wherein said U-shaped geometry translates a weight force of the curtain rod to said mounting surface.

2. The device of claim 2, wherein said locking mechanism is operable to prevent the curtain rod from rotating and/or prevent the curtain rod from jerking out of said U-shaped geometry.

5. The device of claim 1, wherein said bracket shaft is fixed at both ends to said bracket support plate and said curtain bracket may rotate about a neutral axis of said bracket shaft.

6. The device of claim 1, wherein said bracket support plate is operable to join to said wall mount with a fastener positioned at a strategic location on the wall mount.

7. The device of claim 6, wherein strategic locations on said wall mount distribute a weight of said bracket support plate evenly.

8. The device of claim 1, comprising a plurality of fasteners, said plurality of fasteners is positioned at various locations on said bracket support plate.

9. The device of claim 8, wherein said various locations location reduce the stress concentration of said fasteners.

10. The device of claim 1, wherein said attachment member is operable to attach to a surface and support the weight of said wall mount without damaging said surface during removal.

11. The device of claim 10, wherein said attachment member comprises a hook a loop material.

12. The device of claim 1, wherein said device for supporting a curtain rod may be a temporary support.

13. The device of claim 10, wherein said surface is not damaged when the present invention is disassembled.

14. A device for supporting a curtain rod, which comprises:
a. a curtain rod bracket operable to receive a curtain rod, said curtain rod bracket having an obliquely angled slot for receiving said curtain rod;
b. a bracket shaft about which said rod bracket may rotate;
c. a bracket support plate, comprising at least one fastener with a pre-determined geometry;
d. a wall mount, comprising at least one joining location for receiving said fastener, wherein said joining location is complementary to the geometry of said fastener; and
e. an attachment member operable to attach said wall mount to a mounting surface, wherein a portion of the weight force of a curtain rod positioned in said rod bracket is directed in a non-vertical direction against said mounting surface.

15. The device of claim 14, wherein said obliquely angled slot has a U-shaped geometry operable for nesting said curtain rod and prevent slip.

16. The device of claim 14, wherein said U-shaped geometry translates a majority of said weight force of said curtain rod into a mounting surface.

17. The device of claim 14, wherein said bracket shaft is fixed at both ends to said bracket support plate and said curtain bracket may rotate about a neutral axis of said bracket shaft.

18. The device of claim 14, wherein said bracket support plate is operable to join to said wall mount with a fastener positioned at a strategic location on the wall mount.

19. The device of claim 18, wherein strategic locations on said wall mount distribute a weight of said bracket support plate evenly.

20. The device of claim 1, comprising a plurality of fasteners, said plurality of fasteners is positioned at various locations on said bracket support plate.
